(19) United States
(12) Patent Application Publication
(10) Pub. No.: US 2012/0255391 A1
(43) Pub. Date: Oct. 11, 2012

(54) LIGHTWEIGHT MATERIAL, NOTABLY COMPOSITE MATERIAL, BICYCLE HANDLEBAR STEM

(75) Inventor: Jean-Marc Gueugneaud, St. Clair de La Tour (FR)

(73) Assignee: Time Sport International, Vaulx-Milieu (FR)

(21) Appl. No.: 13/437,132

(22) Filed: Apr. 2, 2012

(30) Foreign Application Priority Data
Apr. 5, 2011 (FR) 1152913

(51) Int. Cl. B62K 21/12

(52) U.S. Cl. 74/551.1

(57) ABSTRACT

Bicycle handlebar stem including a lightweight material, notably composite material, body (2) provided with at least one housing to receive a cylindrical part, and means (S) for clamping that part in the housing to assemble the stem and said part; the clamping means (S) comprise at least two studs (6) fixed in the stem body (2) in the vicinity of the housing (3) to project from the body, the stem including in a part facing but spaced from the area provided with the studs at least two conjugate holes (8) adapted to have the studs pass through them, and a nut (9) associated with each stud to clamp the cylindrical element in the stem, this clamping being obtained without causing the studs to turn in the stem body.

### PRIORITY

Priority is claimed to French patent application No. 11/52913, filed Apr. 5, 2011, the disclosure of which is incorporated herein by reference in its entirety.

### BACKGROUND

The invention concerns a bicycle handlebar stem including a lightweight material body provided with at least one housing to receive a cylindrical part and means for clamping that part in the housing to assemble the stem and said part.

The invention concerns more particularly, but not exclusively, a composite material stem.

By lightweight material is meant a material the density of which is less than half that of steel, such materials including aluminum, magnesium, light alloys and composite materials. A composite material is generally constituted of fibers of a material of high mechanical strength, notably carbon fibers or glass fibers, buried in a resin.

The invention notably concerns the fixing of a handlebar in a bicycle stem a stem cap of which is clamped onto the handlebar and the body by the clamping means.

The invention likewise concerns the system for fixing the stem onto the stem tube.

On a bicycle, the stem is a mechanical safety member making the junction between the frame and fork assembly and the handlebar. At present this junction must conform to the standard EN14781. This very severe standard makes it virtually impossible to produce a stem with only two screws to clamp the cap that connects the handlebar to the stem body. The screw heads break during fatigue tests. New stems are thus for the most part stems with four screws.

However, competition in terms of component weight also applies to the stem. There is therefore a great benefit in producing the latter in a lightweight, notably composite material. Composite materials, or more generally lightweight materials, although they have very competitive structural characteristics, are nevertheless softer and more sensitive to abrasion than heavier metals.

A traditional nut-and-bolt assembly is not risk-free, especially when it is considered that the stem and the handlebar may be assembled and dismantled several times (to adjust the handlebar), especially as this manipulation may be effected by a user, who rarely has the appropriate technical knowledge.

In this context, it appears difficult to produce a traditional assembly in a composite material stem with the four cap fixing screws screwed into the composite material. These threads could deteriorate rapidly and there is a high risk of damaging the threads and thus of poor fixing of the cap. This could lead to detachment of the handlebar and cause a serious fall. This problem also arises for a lightweight material. It must not be forgotten that the stem is a safety member.

In the prior art an attempt to stave off this problem has been attempted by bonding an aluminum insert into the interior of a composite material stem, in which insert the screw threads are produced. However, this solution is no longer competitive in terms of weight, all the more so given the necessity of using four fixing screws (additional weight of the screws plus additional weight of the insert, which is necessarily larger). Moreover, the threads of an aluminum insert are relatively fragile, and may be damaged in the event of repetitive screwing and unscrewing, possibly carried out incorrectly.

The most important object of the invention is to propose a bicycle handlebar stem in lightweight material, in particular in composite material, which has none or fewer of the drawbacks referred to above.

### SUMMARY OF THE INVENTION

According to the invention, a bicycle handlebar stem including a lightweight material, notably composite material, body provided with at least one housing to receive a cylindrical part, and means for clamping that part in the housing to assemble the stem and said part, is characterized in that the clamping means comprise at least two studs fixed in the stem body in the vicinity of the housing to project from the body, the stem including in a part facing but spaced from the area provided with the studs at least two conjugate holes adapted to have the studs pass through them, and a nut associated with each stud to clamp the cylindrical element in the stem, this clamping being obtained without causing the studs to turn in the stem body.

An open housing is generally provided at the front of the stem to receive a handlebar, the studs projecting above and below the housing, the facing part of the stem being constituted by a cap for retaining the handlebar in the housing, the cap including holes for the studs to pass through, a nut being associated with each stud to clamp the handlebar between the cap and the body.

The cap may be constituted by a part separate from the stem body.

A housing and studs may be provided at the rear of the stem to receive and clamp a stem tube.

The part of the studs situated in the stem body is advantageously threaded and screwed into the body.

The part of the studs situated in the stem body is preferably glued to that body.

The stem advantageously includes at the front four studs, two above and two below the housing for the handlebar, while the cap includes four holes conjugate with the studs.

The stem may include an insert delimiting the housing for the cylindrical part and the studs are fixed in the insert.

The nuts advantageously include a head with a recessed housing having a polygonal, notably hexagonal, interior contour for a key formed by a rod of solid section with a polygonal contour conjugate with that of the recessed housing.

The threaded hole of the nut leads into the hollow housing of the head.

### BRIEF DESCRIPTION OF THE DRAWINGS

Apart from the features set out above, the invention consists in a certain number of other features referred to more explicitly hereinafter in relation to an embodiment described with reference to the appended drawings that is no way limiting on the invention. In the drawings:

FIG. 1 is a perspective view from the front of a stem body of the invention before fitting the studs.

FIG. 2 shows in a similar way to FIG. 1 the stem body after fitting the studs.

FIG. 3 shows in a similar way to FIG. 1 the stem body in which the handlebar has been placed, the cap being mounted on the studs without yet being clamped.

FIG. 4 shows, in a similar way to FIG. 3, the stem body, the handlebar, the cap and the nuts to be screwed onto the studs.

FIG. 5 shows, in a similar way to FIG. 4, the stem body, the handlebar and the cap clamped against the handlebar by the nuts screwed onto the studs.

FIG. 6 is a partial vertical half-section to a larger scale of the assembled stem, the handlebar not being shown, and

FIG. 7 is an exploded perspective view of the stem of the invention.

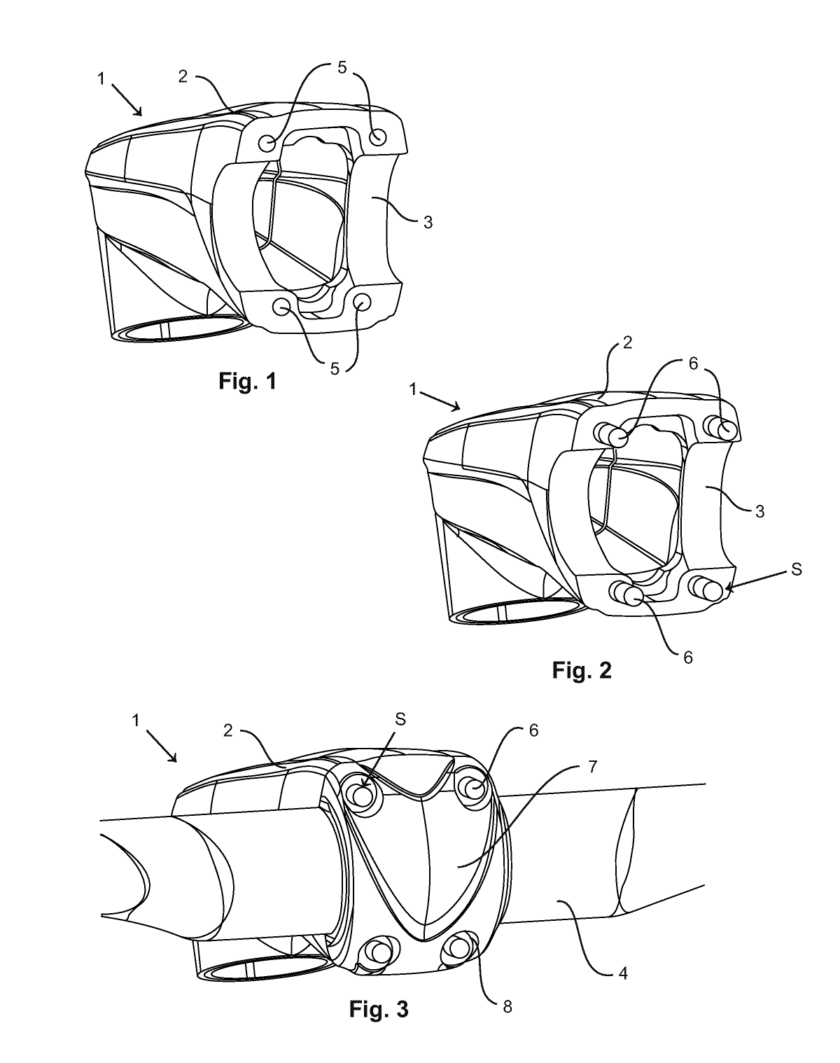

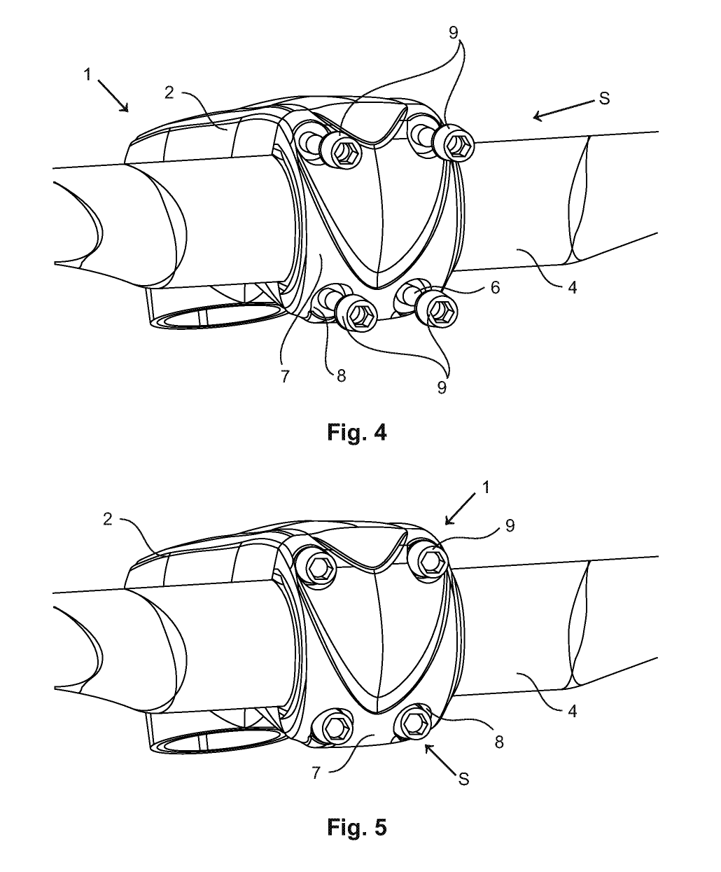

### DETAILED DESCRIPTION OF THE PREFERRED EMBODIMENT

Referring to the drawings, there may be seen a bicycle handlebar stem 1 including a composite material body 2 provided at the front (in the direction of forward movement of the bicycle) with a housing 3 to receive a handlebar 4. The semicylindrical housing 3 is open toward the front. The body 2 is advantageously constituted by a composite shape obtained by molding or overmolding. The body 2 includes threaded holes 5 surrounding the housing 3, advantageously four threaded holes 5, respectively two above and two below the housing 3 and the handlebar 4.

Means S for clamping the handlebar 5 comprise studs 6, each stud 6 being fixed into a threaded hole 5 in the stem body. The studs 6 project from the body 2, the projecting part of each stud being threaded.

The part of the stem facing the housing 3 is constituted by a cap 7 separate from the body. The cap includes four holes 8 for the studs 6 to pass through. A nut 9 is associated with each stud 6 for clamping the handlebar 4 between the cap 7 and the body 2. Clamping is obtained by turning the nut 9 relative to the stud 6 without causing the stud 6 to turn in the stem body 2.

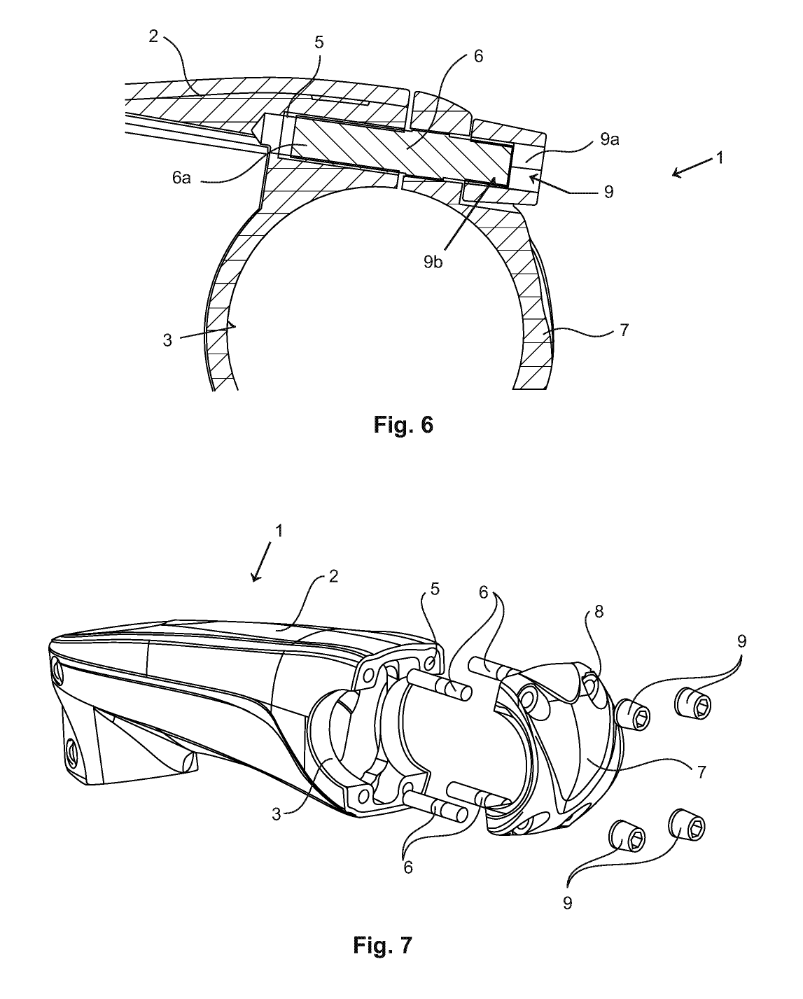

The part 6a (FIG. 6) of the studs 6 situated in the stem body 2 is generally threaded and screwed into the body. This part could not include a thread. The part 6a is advantageously fixed in the body 2 by gluing.

Alternatively, the body 2 may include an insert, possibly a metal insert, fixed in the body in particular by gluing, delimiting the housing 3, the studs 6 being fixed in the insert.

The nuts 9 include a head with a recessed housing 9a, having a polygonal, notably hexagonal interior contour, with six flats, and a smooth, notably frustoconical exterior contour. A bearing washer, not shown, is generally provided between the nut and the cap. The nut 9 is rotated by a key formed by a rod of solid section with a polygonal contour conjugate with that of the recessed housing 9a in which it is engaged. Such a key is known as an “Allen” key. The threaded hole 9b (FIG. 6) of the nut 9 leads to the recessed housing 9a provided for the maneuvering key.

According to the invention, the cap 7 is not clamped by screws. The studs 6 are positioned in the body either by molding or by screwing/gluing. The cap 7 is then clamped by four nuts 9, notably preceded by a washer to prevent friction of the cap during tightening. This solution avoids using an aluminum insert in the body and a saving of 10% in the mass of the part may thus be envisaged.

The stem produced in this way may be obtained directly by molding, thus avoiding machining for subsequent reworking, or by a posteriori gluing of a composite material insert.

Replacing screws by studs also has another benefit. In the prior art, the critical point on the screws is at the screw head. The screw head/body connection causes a discontinuity of shape (relief radius less than 0.2 mm) which implies very high stress concentrations. With the stud the screw head is replaced by a nut 9. There is therefore no longer any such discontinuity of shape. There are no longer any stress concentrations that pass from the body to the head. This contributes to improving the fatigue resistance of the fixing (the force determining the size).

Clamping the cap 7 with aluminum nuts 9 may be envisaged because the bending force under load is taken by the stud 6 which will be in steel. Slightly reducing the size of the studs may also be envisaged, because the absence of a head reduces the appearance of cracks caused by stress concentration. This works towards proposing a safe solution that is very competitive in terms of weight.

In the same line of thinking, this solution using studs 6 fixed in the stem body, notably molded into a stem insert, may be applied to fixing the stem to the stem tube, also known as the fork pivot. At the rear, the fork pivot is clamped between two hollow semicylindrical parts of the stem, the geometrical axis of which is orthogonal to that of the housing 3, separated by a slot. One of the semicylindrical rear parts of the stem constitutes the housing and includes the studs fixed on either side of this housing. The other semicylindrical part, fastened to the stem body, constitutes the facing part including the holes through which the studs pass. The two parts are moved elastically toward each other by screwing nuts onto the studs, clamping the fork pivot.

The metal insert if any responsible for supporting the handlebar and the fixing elements may be assembled to the stem body 2 by any appropriate means, notably chosen from gluing, overmolding, mechanical locking.

The invention applies to any type of composite material, notably to materials with a thermoplastic matrix.

The invention applies equally to stems in alloy or light or “soft” metal, notably in magnesium.

1. A bicycle handlebar stem including a lightweight material, notably composite material, body (2) provided with at least one housing to receive a cylindrical part, and means (S) for clamping that part in the housing to assemble the stem and said part,
wherein the clamping means (S) comprise at least two studs (6) fixed in the stem body (2) in the vicinity of the housing (3) to project from the body, the stem including in a part facing but spaced from the area provided with the studs at least two conjugate holes (8) adapted to have the studs pass through them, and a nut (9) associated with each stud to clamp the cylindrical element in the stem, this clamping being obtained without causing the studs to turn in the stem body.

2. The stem according to claim 1, wherein an open housing (3) is provided at the front to receive a handlebar (4), the studs (6) projecting above and below the housing, the facing part of the stem comprising a cap (7) for retaining the handlebar in the housing, the cap (7) including at least two holes (8) for the studs to pass through, the nut (9) being associated with each stud to clamp the handlebar between the cap and the body.

3. The stem according to claim 2, wherein the cap (7) further includes a part separate from the stem body.

4. The stem according to claim 2, wherein the clamping means comprises four studs (6), two above and two below the housing (3) for the handlebar, while the cap (7) includes four holes conjugate with the studs.

5. The stem according to claim 1, wherein a housing is provided at the rear of the stem to receive and clamp a stem tube.

6. The stem according to claim 1, wherein the part (6a) of each stud situated in the stem body (2) is threaded and screwed into the body.

7. The stem according to claim 1, wherein the part (6a) of each stud situated in the stem body (2) is glued to that body.

8. The stem according to claim 1, wherein the body includes an insert delimiting the housing for the cylindrical part and the studs are fixed in the insert.

9. The stem according to claim 1, wherein the nuts (9) include a head with a recessed housing (9a) having a polygonal, notably hexagonal, interior contour for a key formed by a rod of solid section with a polygonal contour conjugate with that of the recessed housing.

10. The stem according to claim 9, wherein the threaded hole (9b) of the nut leads to the hollow housing (9a) of the head.
